(19) United States
(12) Patent Application Publication
(10) Pub. No.: US 2020/0164314 A1
(43) Pub. Date: May 28, 2020

(54) PILLAR STITCH - PERMEATE CARRIER

(71) Applicant: LEAR CORPORATION, Southfield, MI (US)

(72) Inventor: TYLER HOPKINS, PALMYRA, PA (US)

(21) Appl. No.: 16/202,775

(22) Filed: Nov. 28, 2018

(51) Int. Cl. B01D 63/10; D04B 21/16; B01D 53/22

(52) U.S. Cl. CPC B01D 63/10; B01D 53/228; D04B 21/16

(57) ABSTRACT

A permeate carrier for reverse osmosis, nanofiltration, ultrafiltration, or microfiltration systems is provided. The permeate carrier includes a tricot knitted fabric sheet which includes synthetic yarns knitted into pillars formed by a 1-0, 0-1 lapping pattern or a 0-1, 1-0 lapping pattern and cross ribs formed by a 2-3, 1-0 lapping or a 1-0, 2-3 lapping pattern. The permeate carrier is configured for placement between adjacent filter membranes in a water filtration system.

### TECHNICAL FIELD

In at least one aspect, the present invention is related filter elements for reverse osmosis, nanofiltration, ultrafiltration, or microfiltration systems; and in particular to, filter elements that include permeate carriers.

### BACKGROUND

Membrane filtering elements for reverse osmosis, nanofiltration, ultrafiltration, or microfiltration systems are provided by U.S. Pat. Nos. 4,802,982; 7,862,718; and 9,636,637; and by U.S. Pat. Pub. Nos. 20130098829; 20130337708; and 20120328844. Although these filtering elements work reasonably well, improvements of these filtering elements is desired.

### SUMMARY

In at least one embodiment, the present invention solves one or more problems of the prior art by providing a permeate carrier for a filtration system. The permeate carrier includes a tricot knitted fabric sheet which includes synthetic yarns knitted into pillars formed by a 1-0, 0-1 lapping pattern or a 0-1, 1-0 lapping pattern and cross ribs formed by a 2-3, 1-0 lapping or a 1-0, 2-3 lapping pattern. The permeate carrier is configured for placement between adjacent filter membranes (e.g., water filter membrane, air filter membrane, etc.) in a filtration system and, in particular, a water filtration system. Advantageously, the permeate carrier can be used for reverse osmosis, air filtration, nanofiltration, ultrafiltration, or microfiltration systems. Moreover, the permeate carrier can be formed by a process that has better material utilization (e.g., thicker permeate carrier with less material than prior art).

In another embodiment, a membrane structure for reverse osmosis, nanofiltration, ultrafiltration, or microfiltration systems, including a filtering element is provided. The membrane structure includes a feed water carrier, a water filter membrane, and a permeate carrier interposed between two water filter membranes. Characteristically, the permeate carrier includes a tricot knitted fabric sheet comprising synthetic yarns knitted into pillars formed by a 1-0, 0-1 lapping pattern or a 0-1, 1-0 lapping pattern and cross ribs formed by a 2-3, 1-0 lapping or a 1-0, 2-3 lapping pattern.

### BRIEF DESCRIPTION OF THE DRAWINGS

FIG. 1 a schematic illustration of a water purification system that includes an embodiment of a water filtering element.

FIG. 2A is a perspective view of the membrane structure with a tear to expose a filtering element.

FIG. 2B is a side view showing a plurality of filtering elements.

FIG. 3 is a top view of the technical face of a tricot fabric sheet.

FIG. 4A provides an illustration of the individual lapping patterns used for an embodiment of a permeate carrier.

FIG. 4B provides an illustration of overlapping of the lapping patterns of FIG. 4A.

FIG. 5 provides is a cross section of a yarn fiber coated with epoxy.

FIG. 6 provides flow rates versus pressure performance for permeate carriers of an embodiment of the invention and two prior art permeate carriers.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

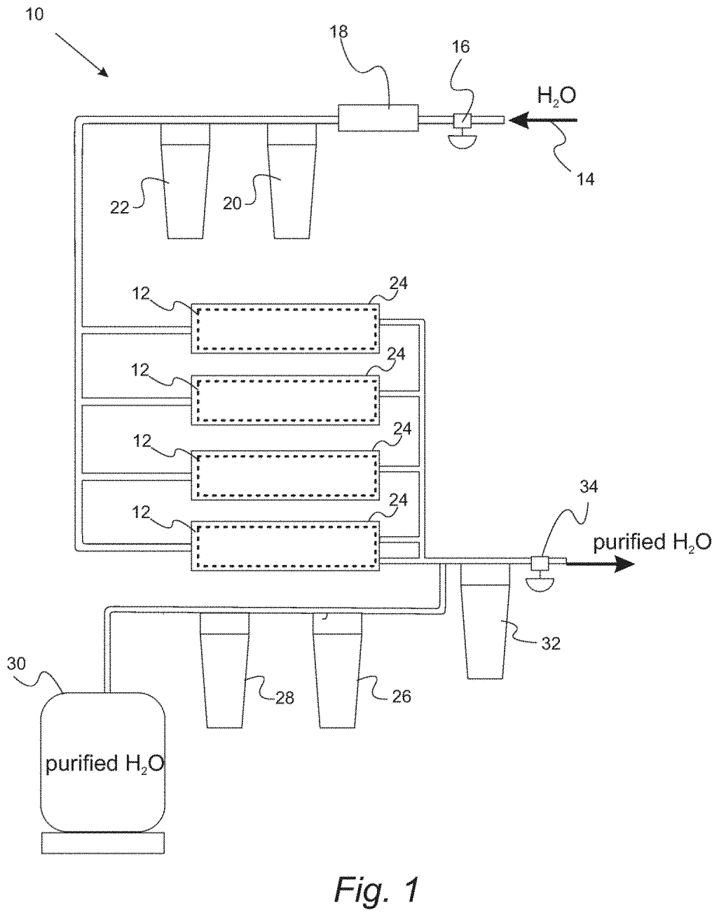

With reference to FIG. 1, a schematic illustration of a water purification system is provided. Water purification system 10 includes one or more membrane structures 12. Advantageously, the water purification system (and membrane structure) can be used for reverse osmosis, nanofiltration, ultrafiltration, or microfiltration systems. Water purification system 10 includes feed water source 14 and a control valve 16 which regulates or controls (e.g., on/off) the flow of the feed water. Typically, the feed water passes through one or more filters 20, 22 prior to passing through membrane structures 12 each of which is enclosed in a housing 24. After the water passes through the membrane structures 12, the water can pass through additional filters 26, 28. Purified water can be stored in tanks 30. In addition, the water from membrane structures 12 can pass through one or more filters 32 and then accessed using valve 34.

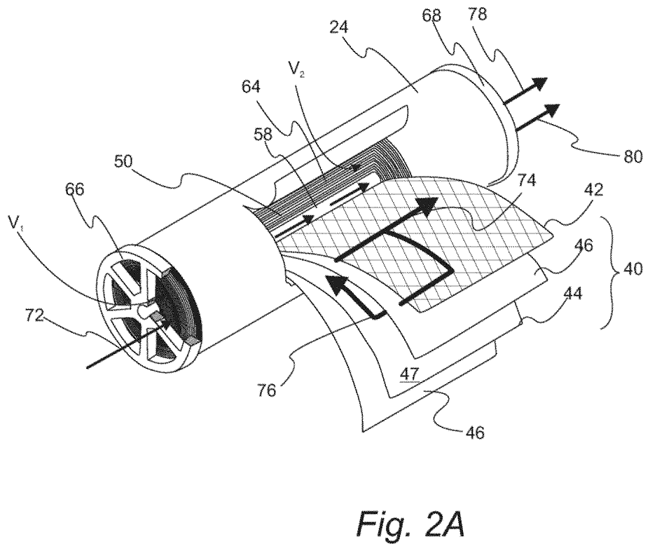

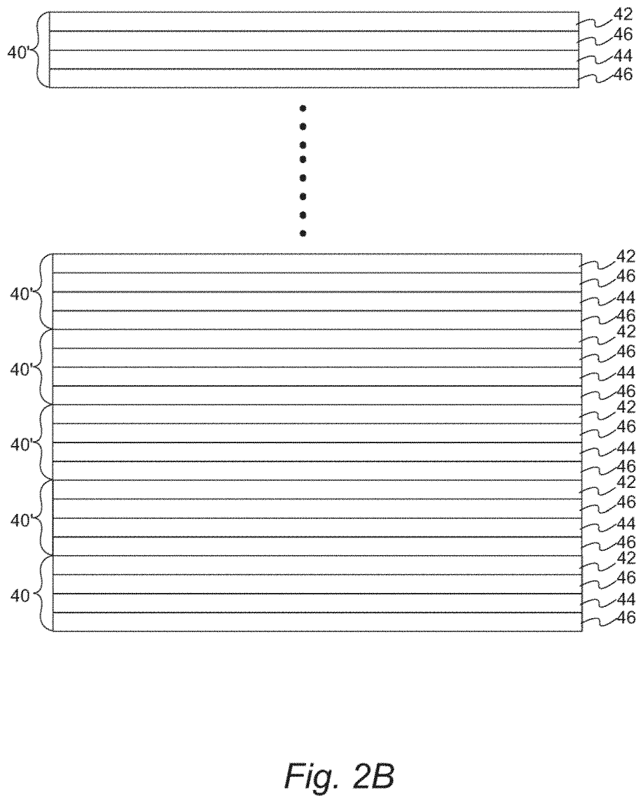

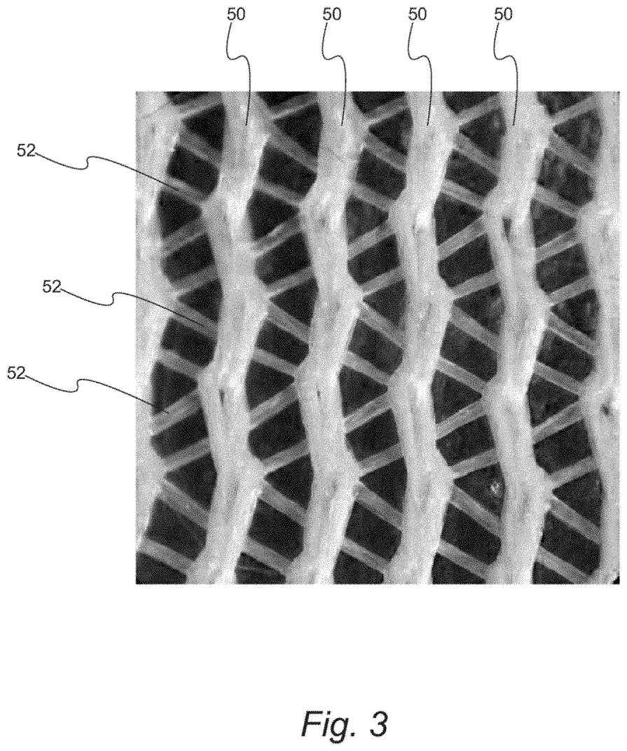

With reference to FIGS. 2A, 2B, and 3, a membrane structure for reverse osmosis, nanofiltration, ultrafiltration, or microfiltration systems with superior flow properties is provided. FIG. 2A is a perspective view of the membrane structure with a tear to expose a filtering element. FIG. 2B is a side view showing a plurality of filtering elements. FIG. 3 is a top view of a tricot fabric sheet from the technical face (i.e., wale-side). Membrane structure 12 includes filtering element 40 having feed water carrier 42, permeate carrier 44, and water filter membrane 46. Characteristically, permeate carrier 44 includes a tricot knitted fabric sheet 47 comprising synthetic yarns knitted into pillars 50 formed by a 1-0, 0-1 lapping pattern or a 0-1, 1-0 lapping pattern and cross ribs 52 formed by a 2-3, 1-0 lapping or a 1-0, 2-3 lapping pattern. Typically, tricot knitted fabric sheet 47 is made on a 2-bar knitting machine. The permeate carrier 44 is interposed between the feed water carrier 42 and a water filter membrane 46. Moreover, the permeate carrier 44 is also interposed between two feed water carriers 42 and the water filter membrane 46. Moreover, permeate carrier 44 is configured to support adjacent water filter membranes 46. Advantageously, the pillars 50 define flow channels along a technical face and technical back (to a lesser extent) of the tricot knitted fabric for flow of fluid being filtered by adjacent filter membranes.

In most applications, membrane structure 12 includes additional filtering elements 40′ which are stacked over filtering element 40. These additional filtering elements overlap with each other and with filtering element 40. The entire stack of filtering elements including filtering element 40 is wound around the perforated tube 58 as shown by end view V₁ and section view V₂. The wound stack 64 of filtering elements 60 attached to perforated tube 62 is positioned in housing 24 and held in place by end caps 66 and 68.

Still referring to FIG. 2A, membrane structure 12 further includes a perforated tube 58 attached to the permeate carrier 44. Perforated tube 58 receives purified water that has passed through the water filter membrane 46. Arrow 72 indicates the introduction of feed water into the wound stack 64. Water flows over feed water carrier 42 as indicated by arrow 74. A portion of the water flows through water filter membrane 46 and is carried by permeate carrier 44 to perforated tube 58 as indicated by arrow 76. The purified water exits the perforated tube 58 as indicated by arrow 78. The concentrated water having the impurities exits the wound stack as a separate concentrate stream indicated by arrow 80. In this regard, the purified water is water having less impurities than the feed water.

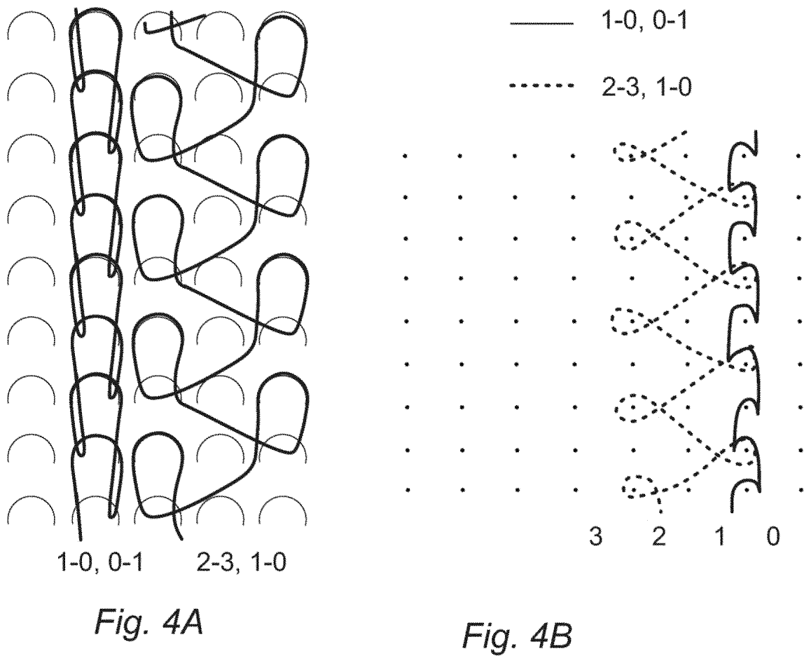

FIGS. 4A and 4B provide an illustration of the lapping pattern used to form permeate carrier 44. In FIG. 4A the lapping patterns for the pillar and ribs (e.g., cross members) are separately illustrated. In FIG. 4B, the composite lapping pattern that forms the tricot knitted fabric sheet is illustrated. As set forth above, permeate carrier 44 includes a tricot knitted fabric sheet comprising synthetic yarns knitted into pillars formed by a 1-0, 0-1 lapping pattern or a 0-1, 1-0 lapping pattern and cross ribs formed by a 2-3, 1-0 lapping or a 1-0, 2-3 lapping pattern. In a refinement, permeate carrier 44 includes a tricot knitted fabric sheet comprising synthetic yarns knitted into pillars formed by a 1-0, 0-1 lapping pattern or and cross ribs formed by a 2-3, 1-0 lapping pattern or pillars formed by a 0-1, 1-0 lapping pattern and cross ribs formed by a 1-0, 2-3 lapping pattern. It should be appreciated that in the full structure, the lapping patterns repeat with either full threading or alternating threading. Characteristically, the permeate carrier is configured for placement between adjacent filter membranes in a water filtration system. Permeate carrier 44 is also characterized by the wale count and course count of the tricot fabric sheet. In a refinement, the wale count of the tricot fabric sheet is from 20 and 70 per inch and the course count of the tricot fabric sheet is between 20 and 70 courses per inch.

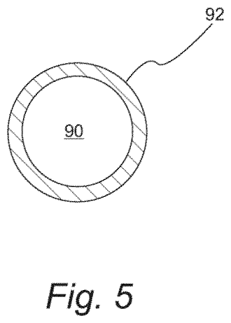

It should also be appreciated that the present invention is not limited by the type of yarn used for the tricot knitted fabric sheet. The synthetic yarns can be monofilament yarns or yarns that include a plurality of filaments. In a refinement, the synthetic yarns include a component selected from the group consisting of polyester yarns, polypropylene yarns, NYLON (i.e., aliphatic or semi-aromatic polyamides) yarns, and combinations thereof. The size of the multifilament yarns is typically from 10 to 100 denier while the size of the monofilament yarns is typically from 20 to 70 denier. In other refinements, the size of the multifilament yarns is typically from 40 to 70 denier while the size of the monofilament yarns is typically from 20 to 50 denier. In a variation, the surface of the tricot knitted fabric sheet can be overcoated with an epoxy layer. In particular, as depicted in FIG. 5, yarn fibers 90 are overcoated or at least partially overcoated with epoxy layer 92.

In a particularly useful variation, the synthetic yarns including a plurality of bicomponent filaments where each bicomponent filament includes an outer sheath region and an inner core region. Characteristically, the outer sheath region has a lower melting point than the inner core region. When bicomponent yarns are used, the tricot fabric sheet is typically heated such that adjacent filaments are fused together. The size of these bicomponent yarns is typically between 10 and 100 denier. In a refinement, the size of these bicomponent yarns is typically between 40 and 70 denier.

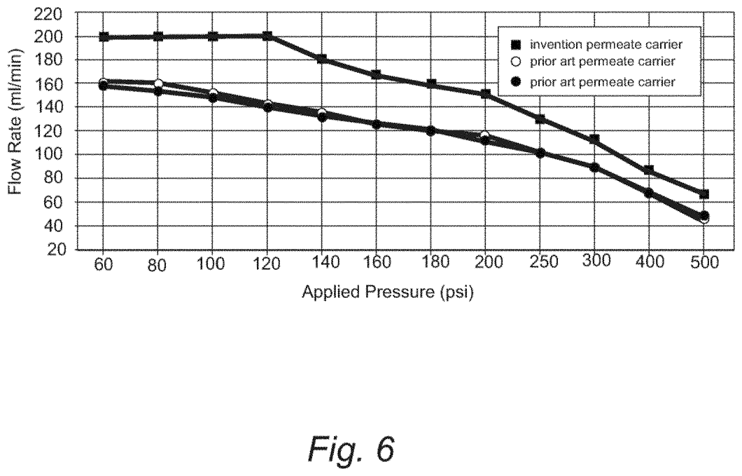

FIG. 6 provides flow rates versus pressure performance for permeate carriers of an embodiment of the invention and two prior art permeate carriers. The example for the present invention shows about 25 to 34 percent flow increase over the tested prior art samples over the pressure range 60 to 500 psi. A 3 inch by 3 inch portion of the finished permeate carrier fabric with one iteration of this design was tested for flow properties against two similar prior art fabrics. Along with a support structure for the fabric comprised of tape layers and sample filtration membranes to simulate behavior in a section of real filtration conditions, the fabric is placed inside a pressurized chamber. Water is introduced into the system at a fixed pressure and funneled through the channels of the fabric being tested. Higher flow translates to better fabric performance for the finished filtration unit. A pressure is applied to the top of this fabric sample, which simulates a pressurized water filtration system. This pressure, as charted on the x-axis of FIG. 5, was increased to 500 psi and the output flow measured for multiple pressures. For this embodiment, flow was consistently higher than prior art with similar wale, course, thickness, and yarn compositions.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A permeate carrier for filtration systems, the permeate carrier comprising:
a tricot knitted fabric sheet comprising synthetic yarns knitted into pillars formed by a 1-0, 0-1 lapping pattern or a 0-1, 1-0 lapping pattern and cross ribs formed by a 2-3, 1-0 lapping or a 1-0, 2-3 lapping pattern, the permeate carrier configured for placement between two filter membranes in a filtration system.

2. The permeate carrier of claim 1 wherein the wale count of the tricot knitted fabric sheet is from 20 and 70 per inch.

3. The permeate carrier of claim 2 wherein the course count of the tricot knitted fabric sheet is between 20 and 70 courses per inch.

4. The permeate carrier of claim 1 wherein the synthetic yarns include a plurality of filaments.

5. The permeate carrier of claim 1 wherein the synthetic yarns are monofilament yarns.

6. The permeate carrier of claim 1 wherein the synthetic yarns include a component selected from the group consisting of polyester yarns, polypropylene yarns, nylon yarns, and combinations thereof.

7. The permeate carrier of claim 1 wherein the synthetic yarns include polyester yarns.

8. The permeate carrier of claim 1 wherein the synthetic yarns include a plurality of bicomponent filaments, each bicomponent filament including an outer sheath region and an inner core region, the outer sheath region having a lower melting point than the inner core region.

9. The permeate carrier of claim 8 wherein adjacent filaments are fused together.

10. The permeate carrier of claim 1 further comprising an epoxy layer overcoated the surface of the tricot knitted fabric sheet.

11. The permeate carrier of claim 1 wherein the pillars define flow channels along the technical face and back of the tricot knitted fabric for flow of fluid being filtered by adjacent filter membranes.

12. The permeate carrier of claim 1 whereby the permeate carrier is configured to support adjacent water filter membranes.

13. A membrane structure for a filtration system, including a filtering element comprising:
a feed water carrier;
a water filter membrane; and
a permeate carrier including a tricot knitted fabric sheet comprising synthetic yarns knitted into pillars formed by a 1-0, 0-1 lapping pattern or a 0-1, 1-0 lapping pattern and cross ribs formed by a 2-3, 1-0 lapping or a 1-0, 2-3 lapping pattern, the permeate carrier interposed between two water filter membranes.

14. The membrane structure of claim 13 further comprising a perforated tube attached to the permeate carrier, the perforated tube receiving purified water that has passed through the water filter membrane, the purified water having less impurities than feed water.

15. The membrane structure of claim 14 wherein the filtering element is wound about the perforated tube.

16. The membrane structure of claim 14 further comprising additional filtering elements wound around the perforated tube.

17. The membrane structure of claim 13 wherein the wale count is from 20 and 70 per inch and the course count is between 20 and 70 courses per inch.

18. The membrane structure of claim 13 wherein the synthetic yarns include a component selected from the group consisting of polyester yarns, nylon yarns, polypropylene yarns, and combinations thereof.

19. The membrane structure of claim 13 wherein the synthetic yarns include a plurality of bicomponent filaments, each bicomponent filament including an outer sheath region and an inner core region, the outer sheath region having a low melting point than the inner core region.

20. The membrane structure of claim 13 wherein the pillars define flow channels along a technical face and technical back of the tricot knitted fabric for flow of fluid being filtered by adjacent filter membranes.
